(19) United States
(12) Patent Application Publication
(10) Pub. No.: US 2025/0009091 A1
(43) Pub. Date: Jan. 9, 2025

(54) Rolling Modular Storage Unit with Drawers

(71) Applicant: Milwaukee Electric Tool Corporation, Brookfield, WI (US)

(72) Inventors: George Barton, Mequon, WI (US); Charlie G. Noble, New Berlin, WI (US); Honesto D. Camposagrado, West Allis, WI (US); Christian R. Braun, Milwaukee, WI (US); Benjamin T. Jones, St. Francis, WI (US)

(21) Appl. No.: 18/763,202

(22) Filed: Jul. 3, 2024

Related U.S. Application Data
(63) Continuation of application No. PCT/US24/34968, filed on Jun. 21, 2024.
(60) Provisional application No. 63/511,770, filed on Jul. 3, 2023.

(51) Int. Cl. A45C 5/06; A45C 5/14; A45C 13/26; B25H 3/02

(52) U.S. Cl. CPC A45C 5/065; A45C 5/14; A45C 13/262; B25H 3/028; A45C 2013/267

(57) ABSTRACT

A rolling storage unit for a modular system is provided. The rolling storage unit includes a main body and one or more drawers positionable within the main body. In various embodiments the one or more drawers include one or more wheels or rollers to provide support for the drawer as the drawer is extended from the main body. In specific embodiments the drawer includes a latch configured to secure the drawer relative to the main body.

### CROSS-REFERENCE TO RELATED PATENT APPLICATIONS

The present application is a continuation of International Application No. PCT/US2024/034968 filed on Jun. 21, 2024, which claims the benefit of and priority to U.S. Provisional Application No. 63/511,770 filed on Jul. 3, 2023, which is incorporated herein by reference in its entirety.

### BACKGROUND OF THE INVENTION

The present invention relates generally to the field of the field of containers and related devices. The present disclosure relates specifically to a rolling modular storage unit with one or more drawers.

Tool storage units are often used to transport tools and tool accessories. Some storage units are designed to incorporate into a modular storage system.

### SUMMARY OF THE INVENTION

One embodiment of the invention relates to a mobile utility module. The mobile utility module includes a main body with an upper surface, a plurality of female couplers defined in the upper surface, wheels coupled to the main body, and a cavity defined within the main body. The mobile utility module further includes a drawer. The drawer includes one or more rollers positioned at a front of the drawer. The drawer is configured to be received within the cavity of the main body. The drawer is movable between a storage position and an extended position in which the drawer extends beyond the main body and the one or more rollers engage a ground surface.

Another embodiment of the invention relates to a rolling modular storage unit. The rolling modular storage unit includes a main body and a drawer. The main body includes an upper surface, a plurality of female couplers defined in the upper surface, a first set of wheels coupled to the main body, and a cavity defined within the main body. The drawer includes a second set of wheels positioned at a front side of the drawer and a locking assembly. The locking assembly is configured to resist movement of the drawer relative to the main body. The drawer is poistionable within the cavity of the main body.

Another embodiment of the invention relates to a mobile utility module. The mobile utility module includes a main body and a drawer. The main body includes an upper surface and a female couplers defined in the upper surface. The female coupler includes a back, a first sidewall, a second sidewall opposite the first sidewall, a first rib extending from the first sidewall toward the second sidewall, and a second rib extending from the second sidewall toward the first sidewall. The main body further includes a first set of wheels coupled to the main body and a cavity defined within the main body. The drawer includes a second set of wheels positioned at a front of the drawer. The female coupler is configured to slidably engage with a male coupler of another utility module.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a rolling modular storage unit, according to an exemplary embodiment.

FIG. 2 is a modular storage unit, according to another exemplary embodiment.

FIG. 3 is a detailed perspective view of a female coupler, according to an exemplary embodiment.

FIG. 4 is perspective view of a male coupler, according to an exemplary embodiment.

FIG. 5 is a right side perspective view of the male coupler of FIG. 4, according to an exemplary embodiment.

FIG. 6 is a side view of a rolling modular storage unit with a wheel in a first position, according to another exemplary embodiment.

FIG. 7 is a side view of the rolling modular storage unit of FIG. 6 with the wheel in a second position.

FIG. 8 is a side view of the rolling modular storage unit of FIG. 6 with the drawer in an extended position.

FIG. 9 is perspective view of a portion of a drawer of a modular storage unit, according to an exemplary embodiment.

FIG. 10 is perspective view of a wheel for the drawer of the modular storage unit, according to an exemplary embodiment.

FIG. 11 is a perspective view of an actuator for a modular storage unit, according to an exemplary embodiment.

FIG. 12 is a side view a rolling modular storage unit, according to another exemplary embodiment.

FIG. 13 is a side view of the drawer of the rolling modular storage unit of FIG. 12, according to an exemplary embodiment.

FIG. 14 is a side view of a wheel system for a rolling modular storage unit, according to an exemplary embodiment.

FIG. 15 is a side view of a wheel system for a rolling modular storage unit, according to another exemplary embodiment.

FIG. 16 is a side view of a wheel system for a rolling modular storage unit, according to another exemplary embodiment.

FIG. 17 is a perspective view of a rolling modular storage unit, according to another exemplary embodiment.

FIG. 18 is a side view of a rolling modular storage unit, according to another exemplary embodiment.

FIG. 19 is a top view of a latch assembly, according to an exemplary embodiment.

FIG. 20 is side view of the latch assembly of FIG. 19, according to an exemplary embodiment.

FIG. 21 is a perspective view of a locking mechanism, according to an exemplary embodiment.

FIG. 22 is a side view of a locking mechanism, according to another exemplary embodiment.

FIG. 23 is a side view of the locking mechanism of FIG. 22, moving into a locked position, according to an exemplary embodiment.

FIG. 24 is a perspective view of a rolling modular storage unit with a drawer locking mechanism, according to an exemplary embodiment.

FIG. 25 is a cross-sectional view of a portion of the drawer of FIG. 24, according to an exemplary embodiment.

FIG. 26 is a cross-sectional view of a portion of the main body of the rolling modular storage unit, according to an exemplary embodiment.

FIG. 27 is a front view of a drawer of a rolling modular storage unit, according to an exemplary embodiment.

FIG. 28 is a sectional view of the drawer taken along line 28-28 in FIG. 27, according to an exemplary embodiment.

FIG. 29 is a side perspective view of a latch assembly in a first position, according to an exemplary embodiment.

FIG. 30 is a side perspective view of the latch assembly of FIG. 29 in a second position, according to an exemplary embodiment.

FIG. 31 is a cross-sectional view of a rolling modular storage unit, according to an exemplary embodiment.

FIG. 32 is a side view a latch assembly in a first position, according to an exemplary embodiment.

FIG. 33 is a side view the latch assembly of FIG. 32 in a second, according to an exemplary embodiment.

FIG. 34 is a detailed view of a latch in a first position, according to an exemplary embodiment.

FIG. 35 is a detailed view of the latch in a second position, according to an exemplary embodiment.

FIG. 36 is a detailed view of a spring in a first position, according to an exemplary embodiment.

FIG. 37 is a detailed view of the spring in a second position, according to an exemplary embodiment.

FIG. 38 is a side view of a rolling modular storage unit, according to another exemplary embodiment.

FIG. 39 is a side view of a rolling modular storage unit, according to another exemplary embodiment.

FIG. 40 is a side view of a locking mechanism for a rolling modular storage unit, according to another exemplary embodiment.

FIG. 41 is a side view of a locking mechanism for a rolling modular storage unit, according to another exemplary embodiment.

FIG. 42 is a perspective view of a rolling modular storage unit, according to another exemplary embodiment.

FIG. 43 is a braking system for a rolling modular storage unit, according to an exemplary embodiment.

FIG. 44 is a perspective view of a braking system for a rolling modular storage unit, according to another exemplary embodiment.

### DETAILED DESCRIPTION

Referring generally to the figures, various embodiments of a rolling storage module/unit with drawers for use with a modular system are shown according to exemplary embodiments. The rolling storage unit includes rolling wheels along the bottom of the storage unit for easy rolling movement of the storage unit. The rolling storage unit includes one or more drawers that can be moved to extend out of the storage unit. As will be generally understood, a conventional rolling storage unit may require removing trays or objects stacked within the container portion of the rolling storage unit. Applicant believes the combination of the wheels on the rolling storage unit and the one or more drawers provides improved mobility relative to a conventional drawer storage unit and improved ease of access to the objects stored within the rolling storage unit. Th rolling storage units discussed herein with drawer(s) that include wheel(s) allows for the opening of the drawer without unstacking any units or boxes engaged or stacked on the rolling storage unit.

In various embodiments, the rolling storage unit is equipped to limit/prevent tipping when the drawer(s) are extended. In various specific embodiments, the drawer(s) include one or more rollers, wheels, or support devices to prevent limit/prevent tipping as the drawers are extended from the rolling storage unit. In various specific embodiments, when the drawer(s) are extended, the drawer(s) travel out and down allowing the wheels to reach the ground. In other embodiments, wheel(s) can be deployed (e.g., spring loaded wheels, manually deployable, etc.) from the drawer bottom such that front of the drawer will be supported by the wheel(s). In various embodiments, the drawer(s) include sliders on the front of the drawer(s) to provide support.

In various embodiments, the rolling storage unit includes a latch for the drawer(s) and/or a brake/lock for the rolling wheels. Applicant believes the use of latch(s) or drawer lock(s) prevents unwanted extension of the drawer(s) that may happen as the user moves the rolling storage unit. In various embodiments, the drawer(s) include latches on the sides of the drawer(s) that engage slot(s) in the main body of the rolling storage unit to lock and unlock the drawer(s) from the body. In various embodiments, the drawer(s) include a grip and arm connected to a ramp such that when a user pulls the grip, the ramp pulls the latch inward (e.g., retracts the latch into the drawer). In various specific embodiments, the drawer lock includes a pin locking mechanism.

As will be generally understood, because the drawer(s) are pulled in order to move the drawer(s) into an extended or open position, the main body of the rolling storage unit may be accidentally moved along with the drawer(s). In various specific embodiments, when the drawer is unlocked or pulled, a brake extends from the main body of the rolling storage to prevent the main body of the rolling storage unit from moving in the same direction as the drawer. In various other embodiments, the main body of the rolling storage unit includes a step brake that is activated when the user steps on a lever, causing the lever to engage the ground. In various embodiments, a handle is rotated to cause a brake to end from the main body of the rolling storage unit.

In various embodiments, the rolling storage unit may include one or more female couplers extend from and/or are located in upper surface of the rolling storage unit, that are configured to engage one or more male couplers of an adjacent modular storage unit. In various embodiments, the male and female couplers described herein and shown in the figures are compatible with the coupling mechanism(s) described in International Patent International Patent Publication No. WO 2017/191628, which is hereby incorporated by reference in its entirety. In various embodiments, the female couplers and male couplers described herein engage with each other to rigidly couple the utility modules that the female couplers and male couplers extend from.

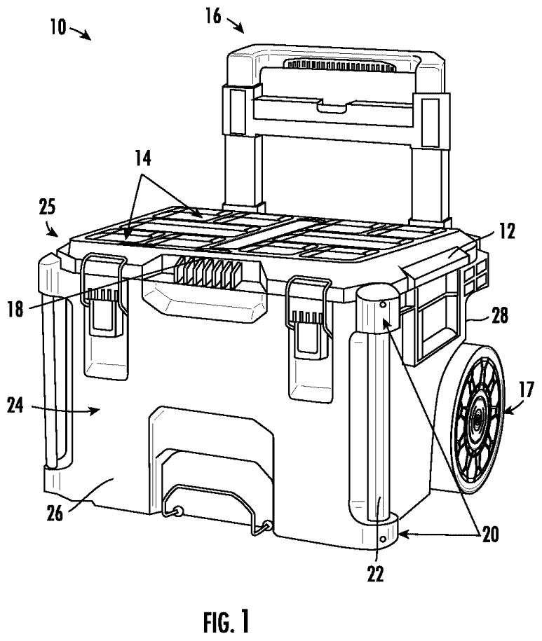

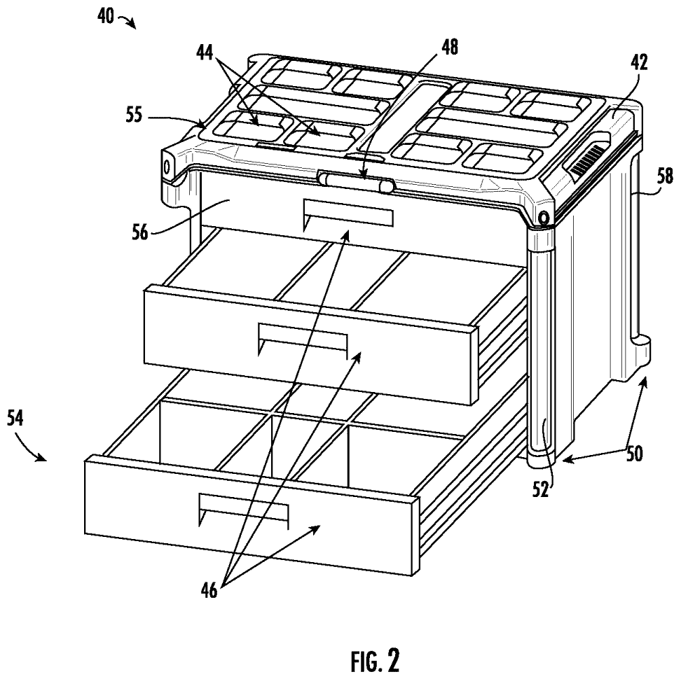

Referring to FIGS. 1-2, details of a rolling storage unit or module 10 and a utility module 40 are shown according to exemplary embodiments. Rolling storage module 10 includes a lid 25 with an upper surface 12 and an opposing lower surface facing away from the upper surface 12. One or more female couplers 14 extend from and/or are located in upper surface 12 of rolling storage module 10. The one or more female couplers 14 are configured to engage one or more male couplers (see e.g., male coupler 172 in FIG. 4) that extend from a surface such as a lower and/or rear surface of another utility module. Rolling storage module 10 includes a latch recess 18 configured to interface with a latches to secure rolling storage module 10 to other objects and/or utility modules.

Rolling storage module 10 includes a main body 24 with a plurality of corners 20. In various embodiments, corners 20 define outermost edges of rolling storage module 10. In various specific embodiments, corners 20 are reinforced with a material such as metal. Rolling storage module 10 further includes a plurality of corner posts or pillars 22 extending between and connecting opposing upper and lower corners 20. In various specific embodiments, corner posts 22 are formed from aluminum and are aluminum extrusion posts. Main body 24 includes a front wall 26 and an opposing rear wall 28. A handle 16 is coupled to main body 24 along rear wall 28. Rolling storage module 10 further includes wheels 17. Wheels 17 are coupled to main body 24 adjacent to rear wall 28.

Referring to FIG. 2, various details of utility module 40 are shown according to an exemplary embodiment. Utility module 40 includes a cover or lid 55 with an upper surface 42. Upper surface 42 includes one or more female couplers 44 located and/or defined in upper surface 42. Utility module 40 includes a latch recess 48 that is substantially the same as latch recess 18.

Utility module 40 includes a main body 54 with a plurality of corners 50. In various embodiments, corners 50 define outermost edges of utility module 40. Unlike rolling storage module 10, utility module 40 does not include wheels. In various specific embodiments, corners 50 are reinforced with a material such as metal. Utility module 40 further includes a plurality of corner posts or pillars 52 extending between and connecting opposing upper and lower corners 50. Utility module 40 includes one or more drawers 46 that can be extended from a front 56 of main body 54 of utility module 40. Main body 54 further includes a rear 58 portion that opposes the front 56.

As previously discussed, in contrast to a conventional rolling storage unit that may require removing trays or objects stacked within the container to find a desired object or tool, drawers can provide faster and easier access to the storage portion of a utility module. Furthermore, Applicant believes the combination of the wheels on the rolling storage unit and the one or more drawers provides improved mobility relative to a conventional drawer storage unit and improved ease of access to the objects stored within the rolling storage unit because no unstacking of any units or boxes engaged or stacked on the rolling storage unit is required.

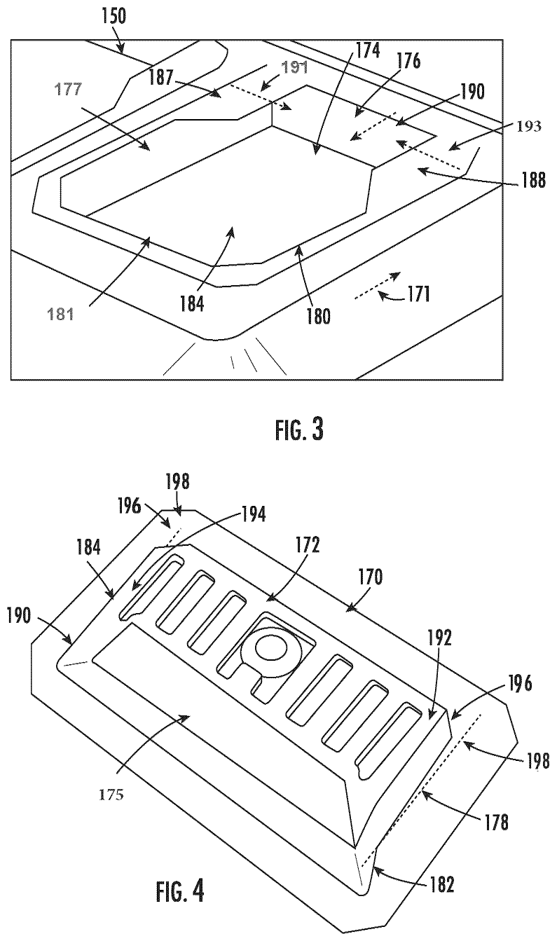

Referring to FIGS. 3-5, various details of male and female couplers that allow for engagement between a rolling storage unit and various other utility modules or storage devices are shown. Various aspects of a female coupler 150 are shown. Female coupler 150 is substantially the same as female couplers 14, 44 and can be utilized with rolling storage modules. In various embodiments female couplers 14, 44 are structurally and functionally the same or similar to female coupler 150.

Female coupler 150 includes a recessed surface 174 below a top or uppermost surface. Backwall 176, opposing front wall 181, first sidewall 178, and opposing second sidewall 180 extend upward from recessed surface 174. Female coupler 150 includes a pocket 184 collectively defined by recessed surface 174, backwall 176, front wall 181, first sidewall 178, and second sidewall 180.

First rib 187 extends from backwall 176 and first sidewall 177 above pocket 184 and/or recessed surface 174. In particular, first rib 187 extends in direction 191 from first sidewall 177 and first rib 187 extends in direction 190 from backwall 176. Second rib 188 extends from backwall 176 and second sidewall 180 above pocket 184 and/or recessed surface 174. In particular, second rib 188 extends in direction 193 from second sidewall 180 and second rib 188 extends in direction 190 from backwall 176. To couple female coupler 150 to a male coupler, such as male coupler 172, the male coupler 172 moves in direction 171 with respect to the female coupler 150.

Referring to FIGS. 4-5, in various embodiments, the utility module and/or storage device includes a male coupler 172 extending from a surface, such as surface 170 of the utility module and/or storage device (e.g., 10, 40, etc.). Male coupler 172 includes a body 175 extending from the surface, a first tongue 186, and a second tongue 186. The first tongue 186 and the second tongue 186 both extend from the body 175 and both are offset from and above the surface. The first tongue 186 defines a first channel 198 between the back surface and the first tongue 186, and the second tongue 186 defines a second channel 198 between the back surface and the second tongue 186. The first channel 198 and second channel 198 each extend on opposing sides (e.g., first side 192 and opposing second side 194) of the body 175.

Each of first channel 198 and second channel 198 includes a front open end and a back closed end. For example, first channel 198 includes a front open end 183 and a back closed end 182, and second channel 198 includes a front open end 183 and a back closed end 182.

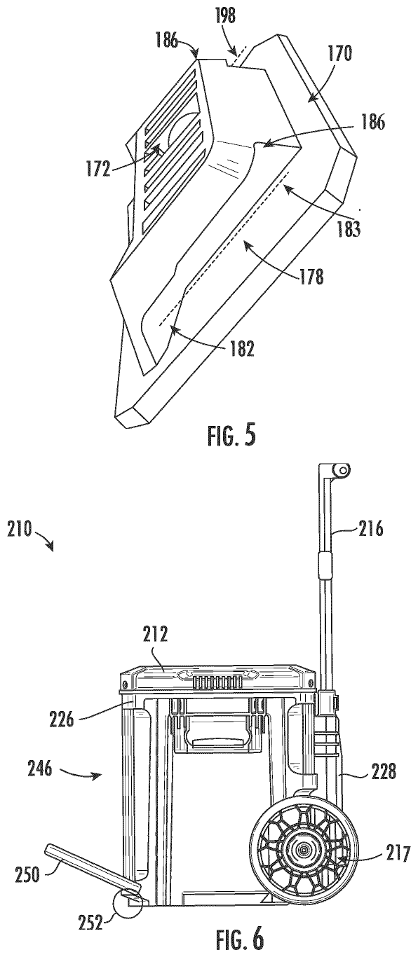

Referring to FIGS. 6-8, various details of rolling utility module 210 are shown according to an exemplary embodiment. As previously discussed, Applicant believes the combination of the wheels on the rolling storage unit (e.g., 10) and the one or more drawers from a stationary utility module (e.g., 40) provides improved mobility relative to a conventional drawer storage. Rolling utility module 210 includes a main body 226 and a drawer 246 that is extendable outward from main body 226. Specifically, main body 226 defines a cavity in which drawer 246 is positioned. Drawer 246 includes one or more rollers shown as wheel(s) 252 coupled to drawer 246 by a connector, shown as wheel support 250. In various embodiments, the one or more rollers is a roller formed from polyoxymethylene (“POM”).

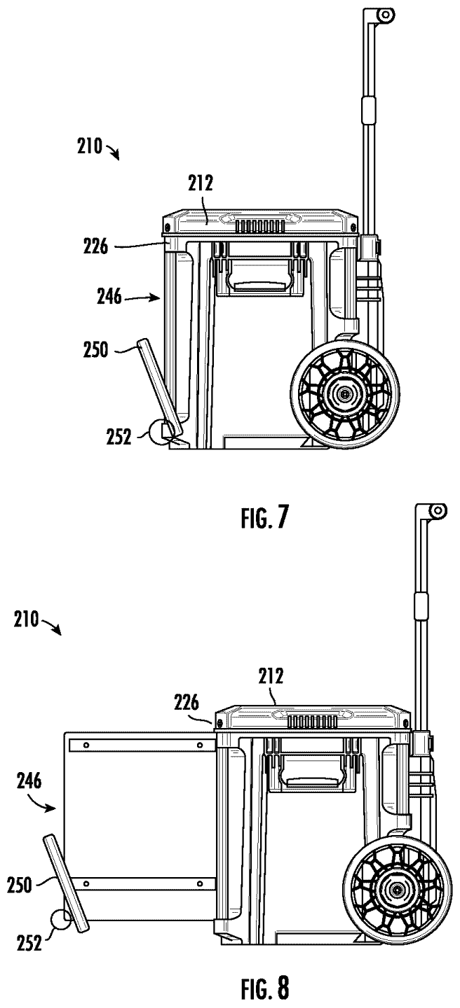

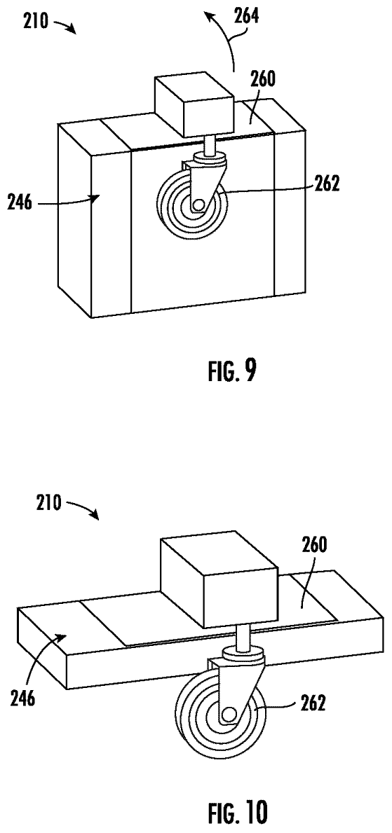

As shown in FIG. 6, when drawer 246 is closed, the wheel support 250 can be moved downward (e.g., in direction toward the ground) allowing rolling utility module 210 to be used as a dolly. As shown in FIG. 7, when the dolly function is not in use and drawer 246 is closed, wheel(s) 252 are above a ground surface and/or not engaged with the ground. When drawer 246 is extended from main body 226 (see e.g., FIG. 8) the wheel support 250 moves downward (e.g., toward the ground) such that drawer 246 is supported in the open or extended position. As will be generally understood, wheel(s) 252 limit/prevent tipping as the drawer 246 is extended from main body 226 of the rolling utility module 210.

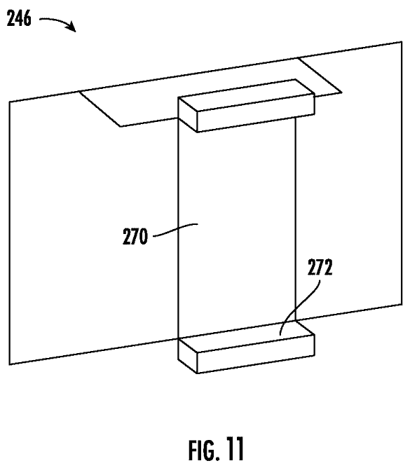

Referring to FIGS. 9-10, details of a roller that can be utilized with rolling utility module 210 are shown, according to an exemplary embodiment. As shown schematically, drawer 246 includes a roller shown as wheel 262 coupled to drawer 246 by a connector, shown as pivotable wheel support 260. Wheel 262 and/or wheel support 262 can be moved or pivoted form a storage position into an active position. When wheel 262 is moved in the direction of arrow 264, wheel 262 pivots with respect to drawer 246.

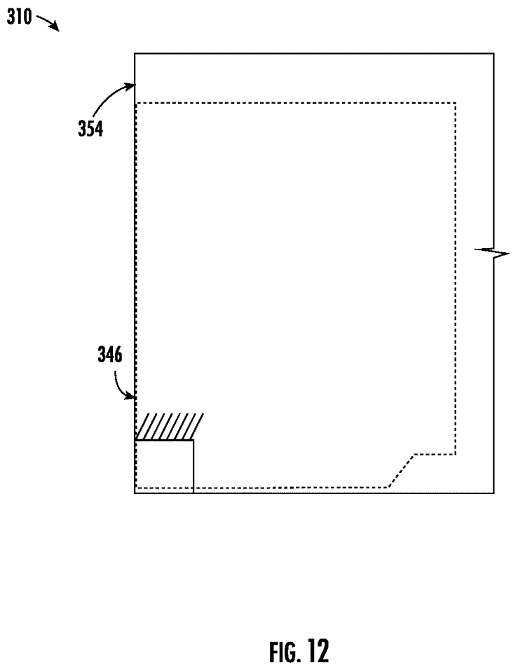

Referring to FIG. 11, details of an actuator that can be utilized with rolling utility module 210 and or wheel 262 is shown, according to an exemplary embodiment. In various specific embodiments a pedal 272 that can be pressed by a foot of a user is connected to a latch 270. When pedal 272 is actuated the wheel 262 and/or wheel support 260 are pivoted. As will be generally understood, the pedal 272 and latch 270 function in a similar manner to a pedal for opening other types of containers (e.g., trash can, etc.).

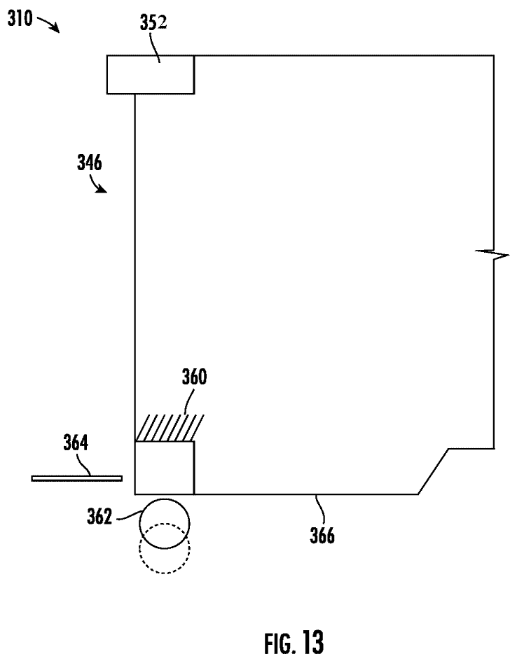

Referring to FIGS. 12-13, various details of a rolling utility module 310 are shown, according to another exemplary embodiment. Rolling utility module 310 is substantially the same as rolling utility module 210 except for the differences discussed herein. A drawer 346 (shown schematically) travels outward and down relative to a main body 354 when drawer 346 is moved into an extended or open position. In such an embodiment, when drawer 346 drops downward (in orientation shown in FIG. 12) toward the ground, drawer 346 does not tip or move the main body 354. When a user moves drawer 346 back into the storage position within main body 354, drawer 346 is lifted upward (i.e., in a direction away from the ground) at the same time drawer 346 is pushed into main body 354.

As shown in FIG. 13, in various specific embodiments, a handle 352 at a top of drawer 346 can be used to actuate a wedge 360 positioned between a body of the drawer 346 and wheel(s) 362 in order to deploy the wheel(s) 362 below a bottom of the drawer 346. For example, in various specific embodiments, a pivot pin can be positioned between the handle 352 and the wedge 360. As will be generally understood, when the wheel(s) 362 are deployed relative to drawer 346, a front 347 of drawer 346 is supported via wheel(s) 362. In other words, weight from drawer 346 is supported by the ground via wedge 360 and wheel(s) 362.

In various specific embodiments, a pedal or lever 364 is coupled to a front of drawer 364. In a specific embodiment, pedal 364 is coupled to a front and center of drawer 346. In such embodiments, actuation of pedal 364 inserts wedge 360 pushes wheel(s) 362 down into the ground.

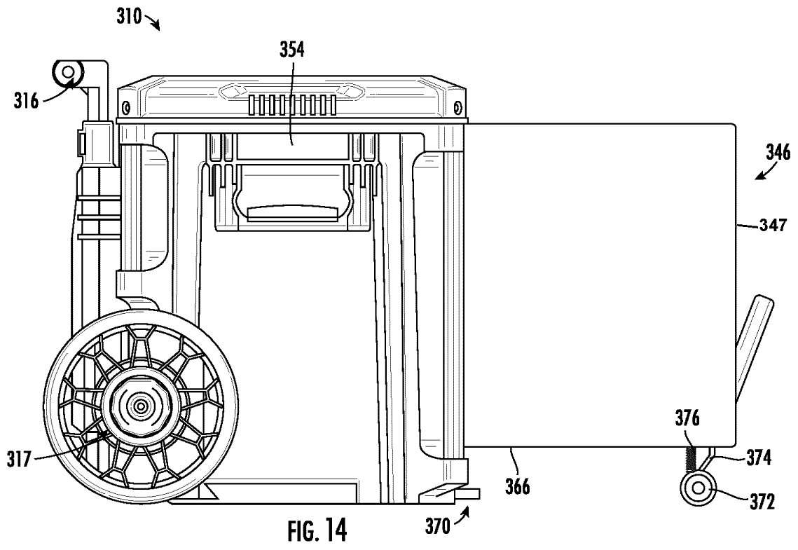

Referring to FIGS. 14-16, details of various wheels and deployment systems that can be utilized with rolling utility module 310 are shown according to exemplary embodiments. In various specific embodiments, one or more wheel(s) 372 are coupled to drawer 346 by a wheel support 374 and a spring 376. In other words, wheel(s) 372 are spring loaded such that wheel(s) 372 automatically deploy when the drawer 346 is extended from main body 354 of rolling utility module 310. Main body 354 further includes a projection 370 extending outward from a front wall of main body 354 that faces away from wheels 317. When drawer 346 is pushed into main body 354 (i.e., moved into a storage position), projection 370 engages a portion of wheel(s) 372 such that wheel(s) 372 automatically retract. In other words, when a user pushes drawer 346 into main body 354, wheel(s) 372 retract without further user interaction.

A front 347 of drawer 346 faces outward, away from main body 354 and/or wheels 317. In contrast, a rear of the drawer 346 faces toward main body 354. As shown in FIG. 14, one or more wheel(s) 372 are positioned below 346 when in the deployed or extended position. In other words, when wheel(s) 372 are deployed, wheel(s) 372 are positioned between a ground surface and drawer 346. In various embodiments, one or more wheel(s) extend from drawer 346 at front 347, where 347 is the portion of drawer 346 positioned furthest from main body 354 when drawer 346 is in the extended position.

Wheels 317 of main body 354 are positioned adjacent to a rear wall of main body 354 along sides of main body 354 and rolling utility module 310. In other words, wheels 317 extend outward relative to the sidewalls of main body 354. In various embodiments, wheels 317 extend outward from the sidewalls and beyond the rear wall of main body 354. The rear wall faces outward, away from drawer 346. In various embodiments, rear wall of main body 354 faces handle 316. In various embodiments, wheels 317 of main body 354 have a dimension that is greater than a dimension of wheels 372 of drawer 346. In various embodiments, wheels 317 of main body 354 have a first diameter and wheels 372 have a second diameter. The second diameter is less than the first diameter.

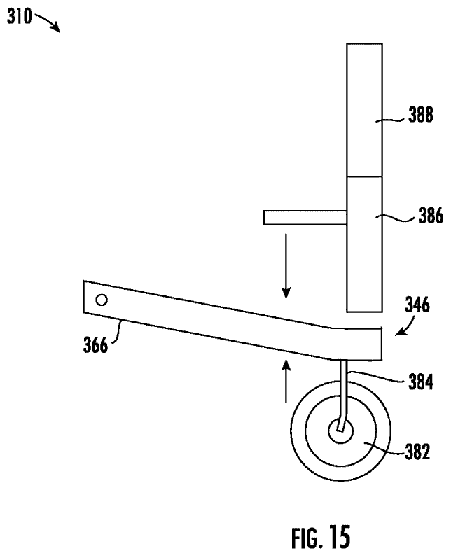

In various embodiments, a user manually deploys wheel(s) 372, such as by engaging a lever. As shown in FIGS. 15-16, a cam 386 coupled to a handle shown as lever 388 can be utilized to deploy wheel(s) 382. In such embodiments, lever 388 can be actuated by a hand or foot of a user for ease of wheel 382 deployment. When wheel(s) 382 are deployed, the position of wheel(s) 382 relative to a bottom surface 366 of drawer 346 is changed. In various embodiments, one or more wheel(s) 382 are spring loaded such that the wheels 382 are biased into a closed or storage position. In such embodiments, the cam 386 has a lever 388 the is engageable by a user such that when lever 388 and cam 386 are rotated (see e.g., FIG. 16) cam 386 pushes wheel(s) 382 down and/or allows a spring to push wheel(s) 382 back up (i.e., toward bottom 366 of drawer 346).

Wheel(s) 382 are moveable between a storage position in which wheel(s) 382 are adjacent to bottom surface 366 of drawer 346 and a deployed position in which the wheel(s) 382 extend away from the bottom surface of drawer 346. In various specific embodiments, bottom surface 366 is a downward facing surface (e.g., in the orientation shown in FIG. 14).

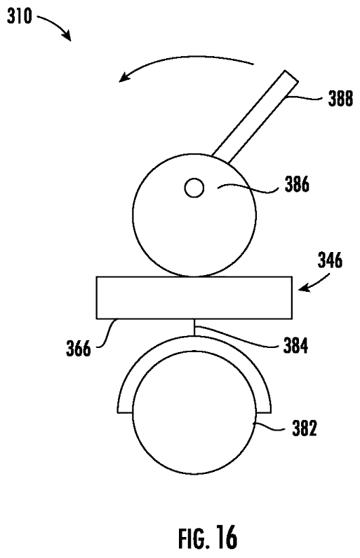

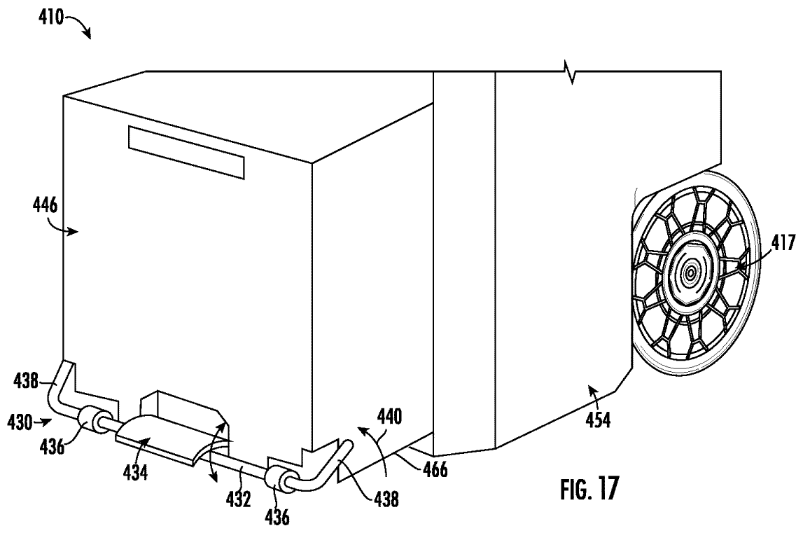

Referring to FIG. 17, details of a rolling utility module 410 are shown according to another exemplary embodiment. Rolling utility module 410 is substantially the same as rolling utility modules 310, 210 except for the differences discussed herein. Rolling utility module 410 includes a drawer 446 and main body 454. A support structure, shown as a wireform 430 is coupled to drawer 446. Wireform 430 includes one or more rollers 436 coupled along a bar 432. In specific embodiments, wireform 430 includes two rollers 436. Wireform 430 includes a pair of pivot arms 438 allowing for movement of wireform 430 relative to drawer 446 and/or a bottom 466 of drawer 446.

In various specific embodiments, rollers 436 are formed from POM. In various specific embodiments, wireform 430 includes a pedal or step 434 to allow users to engage wireform 430. When wireform 430 and/or step 434 are engaged by a user, wireform 430 pivots in a direction shown by arrow 440. Wireform 430 is positioned to only allow for minimal clearance with a ground surface. Applicant believes this allows reduces or limits tipping of drawer 446 when drawer 446 is moved into an extended position relative to main body 454.

Referring to FIG. 18, details of a rolling utility module 510 are shown, according to another exemplary embodiment. Rolling utility module 510 is substantially the same as rolling utility modules 410, 310, 210 except for the differences discussed herein. Rolling utility module 510 includes a drawer 546 with a bottom 566. Bottom 566 of drawer 546 includes a support device (e.g., roller, wheel, etc.) that is fixed in place. In various embodiments, the support device is a roller 562. Applicant believes, roller 562 limits main body 554 from tipping significantly while providing enough support under drawer 546 for a desired amount of stiffness and rigidity. Rollers 562 are formed from a material that slides easily on a ground surface 560. In various specific embodiments, rollers 562 are formed from a POM composite. In various specific embodiments, there is minimal clearance between a bottom of rollers 562 and ground surface 560. In a specific embodiment, the clearance is about ⅛ inches (e.g., ⅛ inch plus or minus 0.05 inches).

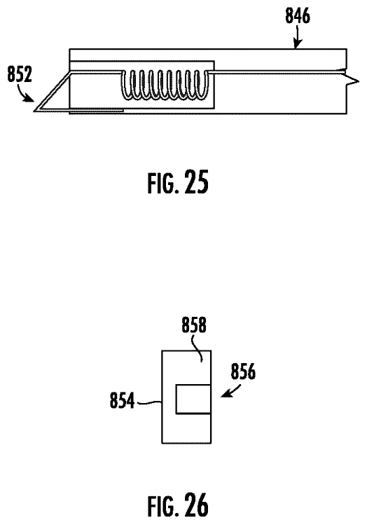

Referring to FIGS. 19-37, various embodiments of latches for the drawer(s) and/or a brake/lock for the rolling wheels are shown according to exemplary embodiments. Applicant believes the use of latch(s) or drawer lock prevents unwanted extension of the drawer(s) that may happen as the user moves the rolling storage unit and the brake prevent moving the entire rolling utility module when only opening the drawer is desired. In other words, the latch or locking assemblies discussed herein, resist the movement of the drawer relative to the main body of the rolling utility module.

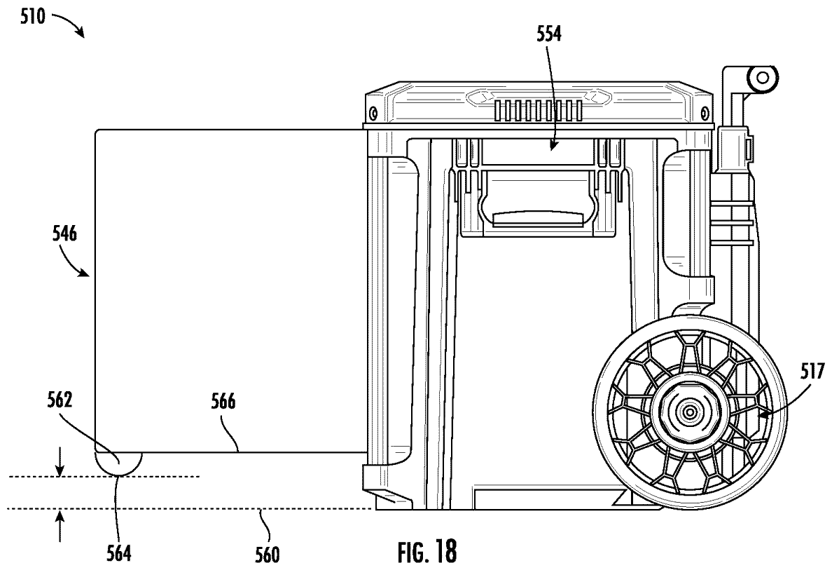

Referring to FIGS. 19-20, a latch assembly 610 is shown according to an exemplary embodiment. Latch assembly 610 includes a latch 612 configured to engage a locking structure 614. A cam surface of latch 612 engages a ramp 616 of locking structure 614. A detent mechanism 620 including a spring 624 and ball 622 are used to lock and/or unlock latch 612. Applicant believes the arrangement of locking structure 614 allows for a user to easily visualize the locking structure and quickly determine whether a drawer of the rolling utility module is locked.

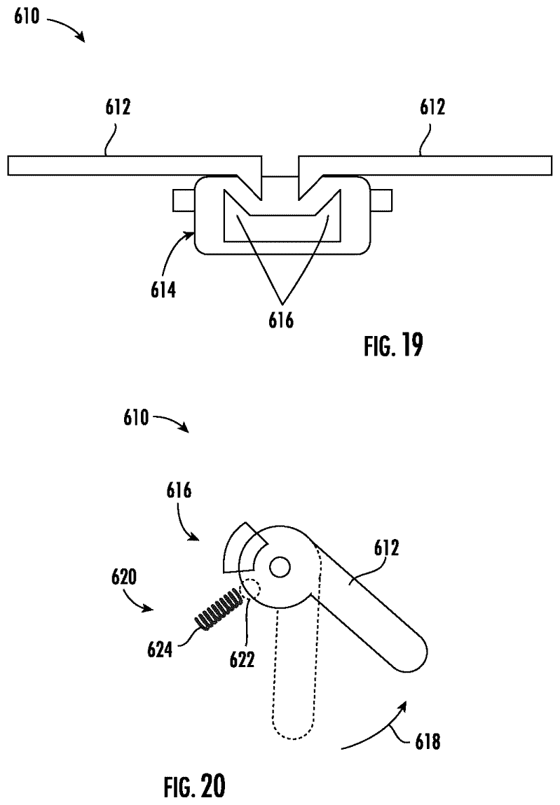

Referring to FIG. 21, various details of locking mechanism that can be utilized with a drawer 646 are shown, according to another exemplary embodiment. Drawer 646 includes a corner 648 that has a vertical structure, such as a vertical extrusion. Drawer 646 includes a spring 652 coupled to a lever 650 such that drawer 646 is spring loaded. In such an embodiment, the spring loaded lever 650 engages with the corner 648 of drawer 646 to keep drawer 646 locked or in a storage position within a main body of the rolling utility module.

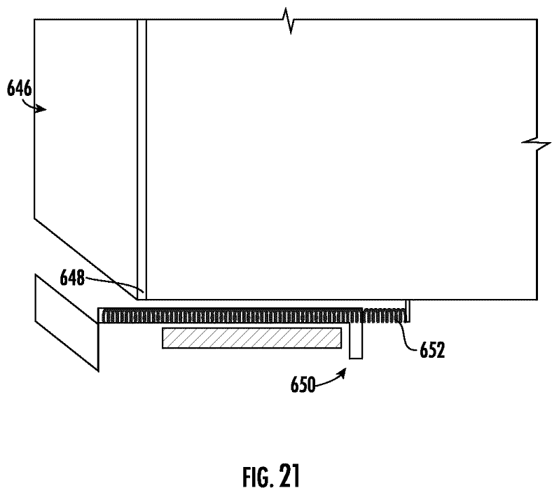

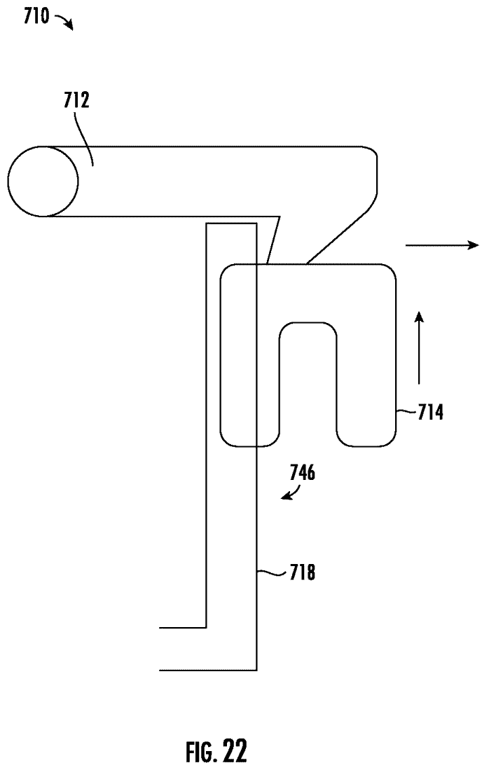

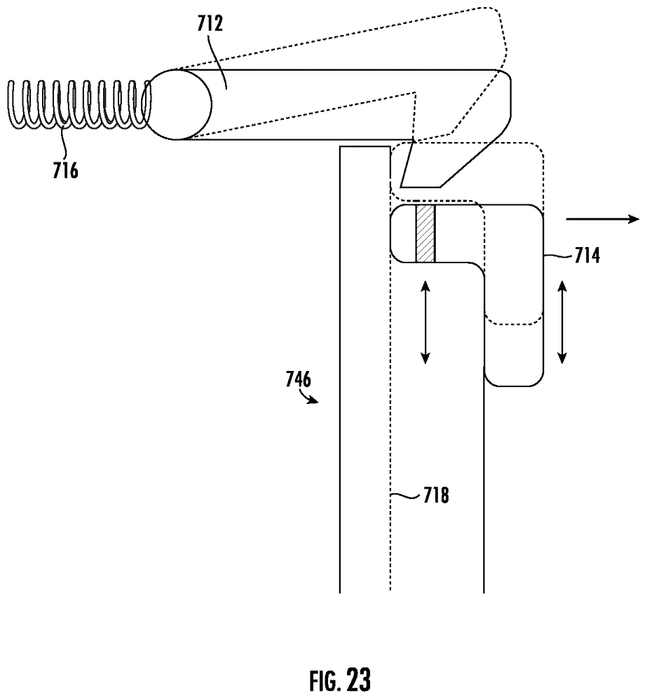

Referring to FIGS. 22-23, details of a latching assembly 710 that can be utilized with a drawer 746 are shown according to another exemplary embodiment. Latch assembly 710 includes a latch 712 configured to engage a front 718 of drawer 746. In various embodiments, drawer 746 includes a moveable handle 714 that interfaces against and/or engages latch 712. In various embodiments, latch assembly 710 further includes a spring 716 coupled to latch 712 such that the latch 712 is spring loaded.

The spring loaded latch 712 prevents the drawer 746 from sliding out of a main body of a rolling utility module. The spring 716 provides a force such that latch 712 presses downward (e.g., in a direction toward drawer 746 and/or ground surface). The handle 714 is slidable and can be moved upward (e.g., in a direction away from ground surface) toward latch 712 to press and move latch 712 up. Once latch 712 has been pressed upward, drawer 746 can be pulled outward into an extended position. When a user is ready to close drawer 746, a ramp on a front of latch 712 can be engaged by a top of drawer 746 to automatically move out of the drawer front 718 as it is closing. Once the front 718 of drawer 746 has pushed past the latch 712 finger or projection, spring 716 pulls the latch 712 and finger back down into a locked position.

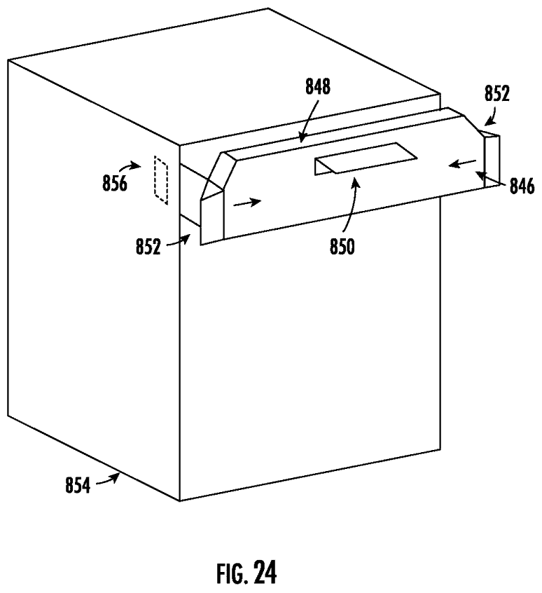

Referring to FIGS. 24-26, details of latch assembly for a rolling utility module are shown according to another exemplary embodiment. Drawer 846 can be extended relative to a main body 854 of the rolling utility module. Drawer 846 includes a handle 850 on a front 848 of drawer 846. Drawer 846 further includes one or more latches 852. The latch 852 is positioned on a side of drawer 846. In specific embodiments, drawer 846 includes two latches 852, with one latch 852 positioned on each side of the drawer 846. The one or more latches 852 are configured to engage with corresponding slots 856 positioned on opposing inner surfaces 858 of main body 854.

When a user lifts the handle 850, the handle 850 pulls latches 852 causing the one or more latches 852 to recede into the front 848 of drawer 846, moving latches 852 out of the slots 856 of main body 854 thereby unlocking drawer 846 from main body 854. When a user is done with drawer 846 the user can close (i.e., slam the drawer shut), moving drawer 846 back into the storage position within main body 854.

Referring to FIGS. 27-28, details of a latching assembly that can be utilized with a drawer 946 are shown according to another exemplary embodiment. A front 948 of drawer 746 includes a grip 954 rigidly coupled to an arm 956 and a sliding ramp 955. In various specific embodiments, the grip 954 are exposed while the arm 956 and sliding ramp 955 are positioned or hidden behind front 948 of drawer 946.

When a user pulls on grip 954, the arm 956 and sliding ramp 955 slide upward. A corresponding sliding ramp 950 of the latch 952 slides and is also pulled inward thereby retracting latch 952 into drawer 946. The sliding ramps 955, 950 translate the lifting motion of grip 954 into a sliding motion of latch 952. FIG. 28 shows a sectional view of grip 954 taken along line 28-28 of FIG. 27.

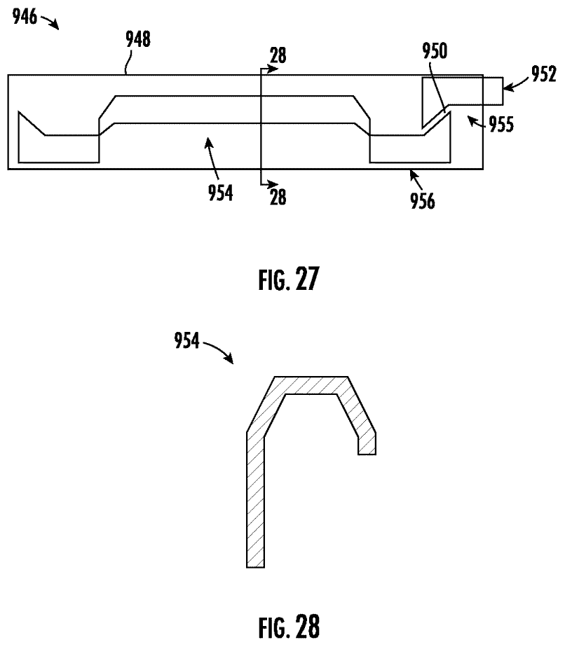

Referring to FIGS. 29-30, details of latch assembly as shown according to another exemplary embodiment. A drawer 1046 includes a spring, shown as leaf spring 1048. Leaf spring 1048 is fixed at one end by a fastener 1050 and moveable at the other end that is engaged with a bracket 1052. The bracket 1052 allows leaf spring 1048 to move along the drawer 1046 (e.g., back and forth), but constrains leaf spring 1048 from moving closer or further away from drawer 1046. In other words, leaf spring 1048 cannot move up and down relative to drawer 1046 in the orientation shown in FIGS. 29-30. In other embodiments, leaf spring 1048 may be attached to the main body of the rolling utility module rather than the drawer.

As shown in FIG. 29, when drawer 1046 is open, leaf spring 1048 bows outward, away from a surface of drawer 1046. As can be seen in FIG. 30, when drawer 1046 is closed, leaf spring 1048 is held in place by a detent 1056 in the main body.

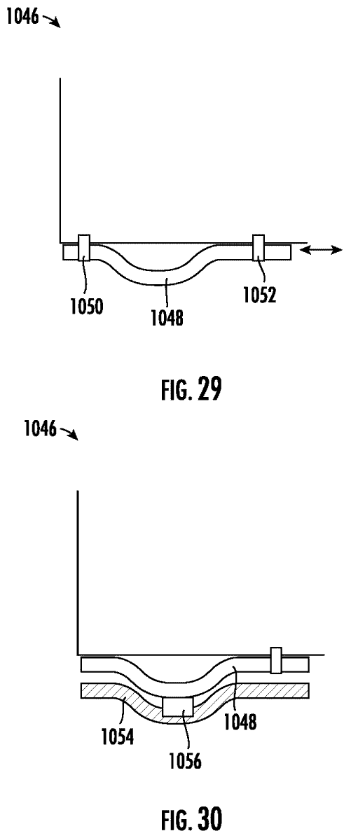

Referring to FIG. 31, details of a locking mechanism shown as a tumbler latch that can be utilized with a utility module 1110, are shown according to an exemplary embodiment. Rolling utility module 1110 is substantially the same as rolling utility modules 510, 410, 310, 210 except for the differences discussed herein. A pin 1150 is biased downward (i.e., toward drawer 1146) by a spring 1152 from main body 1154 to hold drawer 1146 in place. In such a position, pin 1150 prevents drawer 1146 from sliding forward relative to main body 1154 thereby preventing drawer 1146 from opening. When a user presses a bottom button 1148, pin 1150 is pressed fully into main body 1154 thereby allowing the drawer 1146 and button 1148 to slid past main body 1154 such that the drawer 1146 moves into the open or extended position.

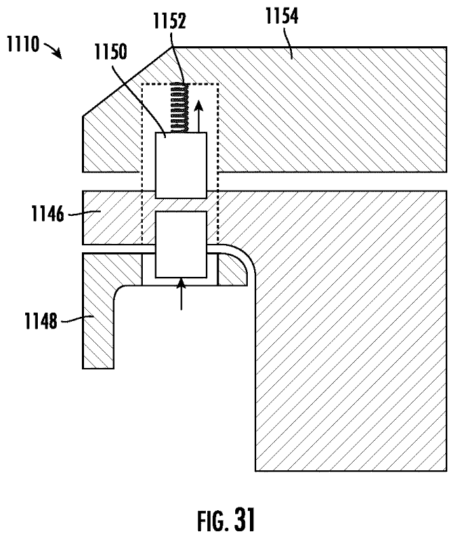

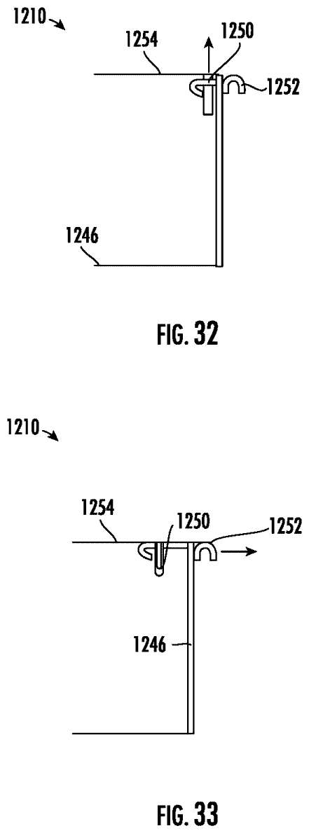

Referring to FIGS. 32-37, various details of a latch assembly that can be utilized with a utility module 1210, are shown according to another exemplary embodiment. Rolling utility module 1210 is substantially the same as rolling utility modules 1110, 510, 410, 310, 210 except for the differences discussed herein. Main body 1254 is engaged by a latch 1252 that includes a projection 1250 and a spring shown as torsion spring 1256 to keep drawer 1246 closed.

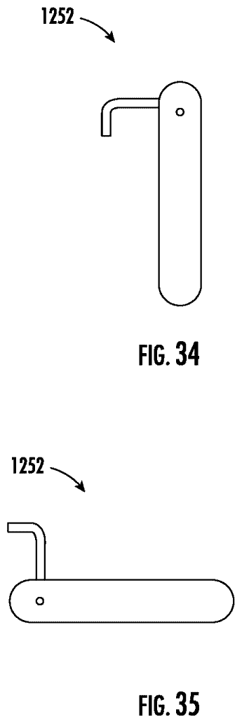

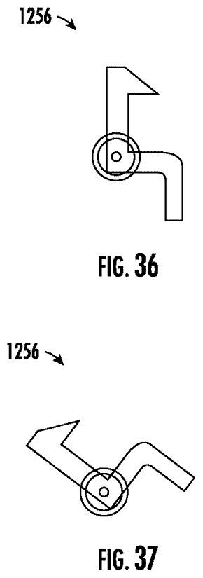

When the main or body portion of latch 1252 is extended along the longitudinal axis of drawer 1246, the drawer 1246 is locked (see e.g., FIG. 34). In the locked position, the torsion spring 1256 is oriented as shown in FIG. 36. When latch 1252 is pulled outward, the orientation of projection 1250 is changed, such that an opening of projection 1250 faces inward, towards drawer 1246 (see e.g., FIG. 35). In the unlocked position, the torsion spring 1256 is rotated into the orientation shown in FIG. 37.

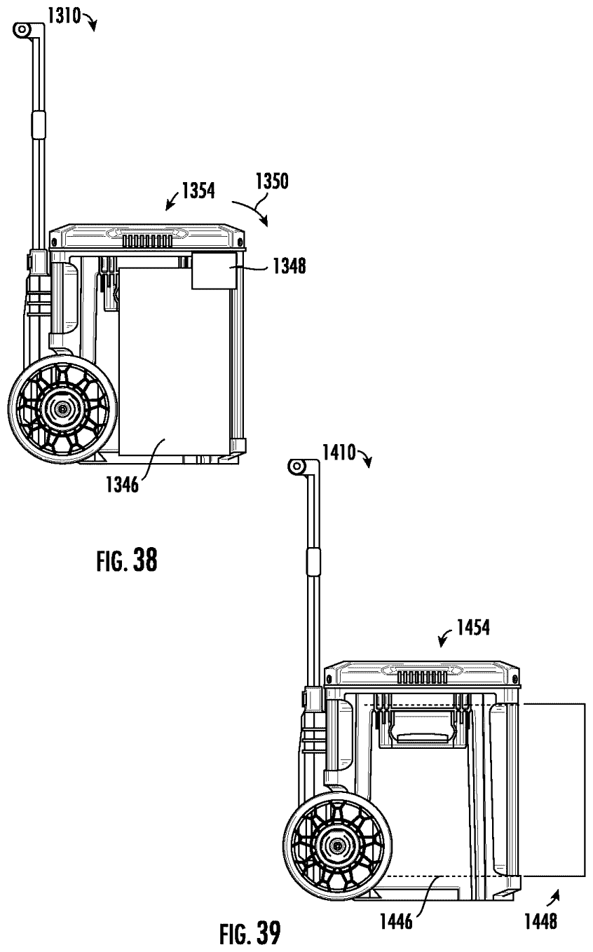

Referring to FIG. 38, details of locking mechanism for a drawer 1346 that can be utilized with a rolling utility module 1310 is shown according to another exemplary embodiment. Rolling utility module 1310 is substantially the same as rolling utility modules 1110, 510, 410, 310, 210 except for the differences discussed herein. A lock 1348, shown schematically, locks drawer 1346 in place within main body 1354 when the rolling utility module 1310 is tipped backward (i.e., in direction of wheels 1317).

Referring to FIG. 39, details of locking mechanism for a drawer 1446 that can be utilized with a rolling utility module 1410 is shown according to another exemplary embodiment. Rolling utility module 1410 is substantially the same as rolling utility modules 1310, 1110, 510, 410, 310, 210 except for the differences discussed herein. A drawer support, shown schematically as a slider 1448, is positioned on a front portion of drawer 1448 to provide support and limit tipping of drawer 1446.

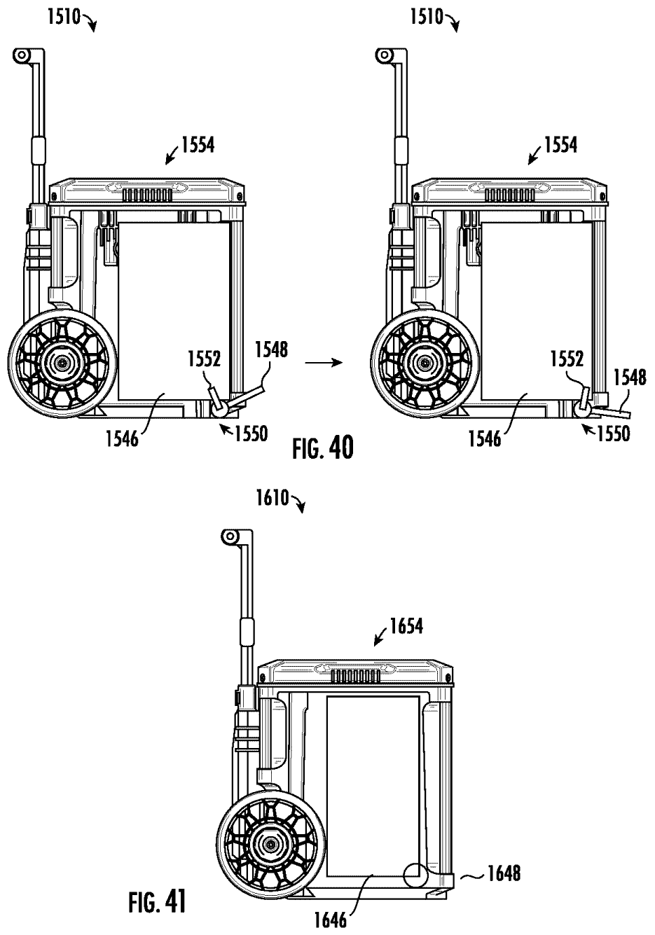

Referring to FIG. 40, details of locking mechanism for a drawer 1546 that can be utilized with a rolling utility module 1510 is shown according to another exemplary embodiment. Rolling utility module 1510 is substantially the same as rolling utility modules 1310, 1110, 510, 410, 310, 210 except for the differences discussed herein. A spring 1552 loaded wheel 1550, shown schematically, is coupled to drawer 1546. A lever, shown as a foot lever 1548 can be actuated to deploy wheel 1550. Due to spring 1553, wheel 1550 will snap back into the undeployed or storage position when foot lever 1548 is released, unless locked in place.

Referring to FIG. 41, details of locking mechanism for a drawer 1646 that can be utilized with a rolling utility module 1610 is shown according to another exemplary embodiment. Rolling utility module 1610 is substantially the same as rolling utility modules 1510, 1310, 1110, 510, 410, 310, 210 except for the differences discussed herein. A tilt structure 1648 is coupled to drawer 1646 to tilt a bottom surface of drawer 1646 relative to main body 1654 of rolling utility module 1610.

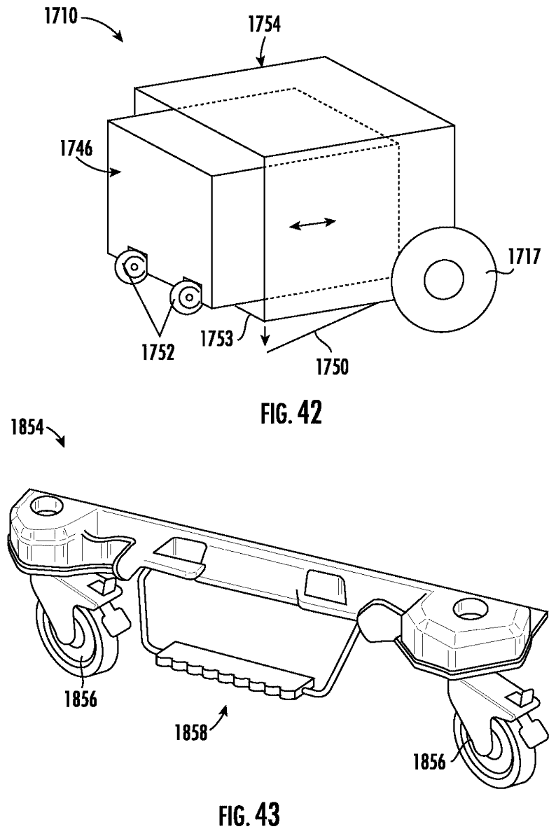

Referring to FIG. 42, details of braking mechanism for a drawer 1746 that can be utilized with a rolling utility module 1710 is shown according to another exemplary embodiment. Rolling utility module 1710 is substantially the same as rolling utility modules 1510, 1310, 1110, 510, 410, 310, 210 except for the differences discussed herein. In such an embodiment, wheels 1742 are always in contact with a ground surface. Main body 1754 pushes a brake 1750 downward, into the ground and or a surface as drawer 1746 is pulled outward into an extended position. As such, the rolling utility module 1710 does not roll around as drawer 1746 is extended from main body 1754.

Referring to FIG. 43, details of a braking mechanism for a main body 1854 of a rolling utility module is shown according to another exemplary embodiment. In such embodiments, a step brake 1858 is coupled to a front portion of main body 1854 such that when a user engages (i.e., steps on) step brake 1858, a lever engages the ground to prevent rolling of wheels 1856 of main body 1854.

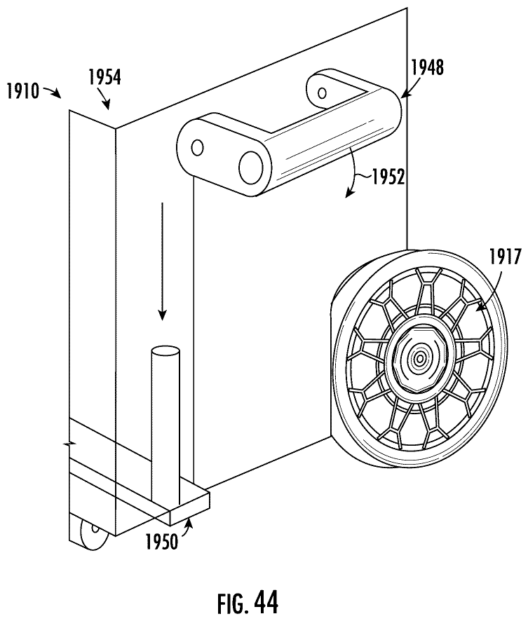

Referring to FIG. 44, details of a braking mechanism for a main body 1954 of a rolling utility module 1910 are shown according to another exemplary embodiment. Rolling utility module 1910 is substantially the same as rolling utility modules 1710, 1510, 1310, 1110, 510, 410, 310, 210 except for the differences discussed herein. In such embodiments, a handle 1948 is coupled to a side portion of main body 1954. When a user engages and rotates handle 1948, a brake 1950 is extend outward from a bottom of main body 1954. Engagement between brake 1950 and the ground prevents the rolling of main body 1954 during extension of drawer 1946.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A mobile utility module comprising:
a main body, the main body comprising:
an upper surface;
a plurality of female couplers defined in the upper surface;
wheels coupled to the main body; and
a cavity defined within the main body; and
a drawer comprising one or more rollers positioned at a front of the drawer, the drawer configured to be received within the cavity of the main body;
wherein the drawer is moveable between a storage position and an extended position in which the drawer extends beyond the main body and the one or more rollers engage a ground surface.

2. The mobile utility module of claim 1, wherein each of the plurality of female couplers is configured for engagement with male couplers of a utility module.

3. The mobile utility module of claim 1, wherein the one or more rollers are wheels.

4. The mobile utility module of claim 1, wherein the front of the drawer faces away from the main body.

5. The mobile utility module of claim 1, wherein the one or more rollers extend below a bottom surface of the drawer.

6. The mobile utility module of claim 4, wherein the main body further comprises a bottom surface of the cavity, wherein the bottom surface of the cavity faces a bottom of the drawer in the storage position.

7. The mobile utility module of claim 1, wherein the wheels of the main body have a first diameter and the one or more rollers have a second diameter, and wherein the first diameter is greater than the second diameter.

8. The mobile utility module of claim 1, further comprising a latch assembly, the latch assembly configured to resist movement of the drawer relative to the main body.

9. The mobile utility module of claim 1, further comprising a brake coupled to the main body, wherein the brake is configured to engage a ground surface such that the brake resists movement of the wheels coupled to the main body.

10. A rolling modular storage unit comprising:
a main body, the main body comprising:
an upper surface;
a plurality of female couplers defined in the upper surface;
a first set of wheels coupled to the main body; and
a cavity defined within the main body; and
a drawer comprising:
a second set of wheels positioned at a front side of the drawer; and
a locking assembly, the locking assembly configured to resist movement of the drawer relative to the main body;
wherein the drawer is positionable within the cavity of the main body.

11. The rolling modular storage unit of claim 10, further comprising a brake coupled to the main body, wherein the brake is configured to engage a ground surface such that the brake resists movement of the first set of wheels.

12. The rolling modular storage unit of claim 10, wherein the locking assembly further comprises a latch that engages an inner surface of the cavity to resist movement of the drawer.

13. The rolling modular storage unit of claim 10, wherein the second set of wheels are movable between a storage position in which the second set of wheels are adjacent to a bottom surface of the drawer and a deployed position in which the second set of wheels are extended away from the bottom surface of the drawer.

14. The rolling modular storage unit of claim 13, wherein the bottom surface of the drawer faces the cavity when the drawer is positioned in the main body.

15. The rolling modular storage unit of claim 10, wherein the front side of the drawer faces away from first set of wheels.

16. A mobile utility module comprising:
a main body, the main body comprising:
an upper surface;
a female coupler defined in the upper surface, the female coupler comprising:
a back;
a first sidewall;
a second sidewall opposite the first sidewall;
a first rib extending from the first sidewall towards the second sidewall; and
a second rib extending from the second sidewall towards the first sidewall;
a first set of wheels coupled to the main body; and
a cavity defined within the main body; and
a drawer comprising:
a second set of wheels positioned at a front of the drawer;
wherein the female coupler is configured to slidably engage with a male coupler of another utility module.

17. A mobile utility module of claim 16, wherein the drawer further comprises a downward facing bottom surface, and wherein the second set of wheels are positioned between the bottom surface and a ground surface, when the drawer extends from the main body.

18. The mobile utility module of claim 16, wherein the second set of wheels engage a ground surface when the drawer is extended from the main body.

19. The mobile utility module of claim 16, further comprising a brake coupled to the main body, wherein the brake extends from the main body to engage a ground surface to resist movement of the first set of wheels.

20. The mobile utility module of claim 16, the drawer further comprising a latch assembly, the latch assembly comprising a latch extending from the drawer to engage the main body and resist movement of the drawer relative to the main body.
